(19) United States
(12) Patent Application Publication
(10) Pub. No.: US 2019/0244278 A1
(43) Pub. Date: Aug. 8, 2019

(54) APPARATUS, METHOD AND SYSTEM FOR ELECTRONIC DEVICE CUSTOMIZATION

(71) Applicant: Elements of Genius, Inc., Mt. Pleasant, SC (US)

(72) Inventor: Jonathan E. Ramaci, Mt. Pleasant, SC (US)

(21) Appl. No.: 16/267,707

(22) Filed: Feb. 5, 2019

Related U.S. Application Data
(60) Provisional application No. 62/626,429, filed on Feb. 5, 2018.

(51) Int. Cl. G06Q 30/06

(52) U.S. Cl. CPC G06Q 30/0635

(57) ABSTRACT

An apparatus, system, and methods for the customization of functions and/or contents of a packaged electronic device within a warehouse or while in route during shipment and delivery to a customer. In broadest terms, the system comprises one or more electronic device with wireless communication means, commerce server, server access device, communication network, and device configurator. The wireless communication means enable the electronic device to be connected to an electronic commerce service, fulfillment, and device configuration system. The electronic device is configured to enable seamless communication with the device customization system. The method includes pre-programming an electronic device at a manufacturing facility, factory, warehouse, or while in route to the ordering customer or other intended recipient.

### CROSS REFERENCE TO RELATED APPLICATIONS

The present application claims the benefit of U.S. Provisional Application 62/626,429, filed on Feb. 5, 2018 and entitled “DEVICE PERSONALIZATION DURING FULFILLMENT,” the disclosure of which is hereby incorporated in its entirety at least by reference.

### FIELD

The present disclosure relates to the field of electronic device pre-programming, provisioning, and/or configuring in the fulfillment of a customer purchase. In particular, the disclosure relates to a system, apparatus, and methods for electronic device customization while in route for shipment.

### BACKGROUND

Consumers are increasingly ordering and purchasing electronic devices from manufacturers and companies through online electronic commerce services (e.g. Amazon. Apple, etc.) for delivery. Online entities offer a wide variety of electronic devices, including personal computers (PCs), electronic book viewers, portable digital assistants (PDAs), pocket PCs, smart phones, smart TVs, set-top boxes such as televisions, digital video recorders (DVRs), smart appliances, and gaming consoles. Once these devices are shipped and delivered, for example, to a home, a purchaser is usually required to set up the device for operation, sometimes in combination with other electronic devices. For example, the purchased electronic device can include communication capabilities enabling the device to pair with a Bluetooth® enabled-device, be accessed and operate within a local area network (LAN), connect to an ISP and subsequently to the Internet through WiFi, or connect to a wireless cellular network. The setup environment can vary depending on the number of communicating devices, the type of devices, their locations, and capabilities. The setup procedure generally requires the user to configure the device for operation within the user's environment (e.g., home, office, car, etc.). The configuration steps can require the user to provide, input or select various information, such as, for example, the network configuration, passwords, other device names, or communication contact info (e.g., mobile phone numbers of contact members). The current drawbacks for electronic devices containing firmware or factory pre-programmed software include that once packaged and shipped they require additional configuration or setup after delivery. In addition, upgrades to the device's firmware or software are generally unfeasible for a packaged device without removing it from packaging. In addition, prior to use by a consumer, the device can require an initialization or a software upgrade which can be lengthy and inconvenient for the consumer during setup.

### SUMMARY

Disclosed are an apparatus, system, and methods for the customization of functions (e.g. setup) and/or contents (e.g., upgrade, music, greeting message, etc.) of a packaged electronic device within a warehouse or while in route during shipment and delivery to a customer. In broadest terms, the system comprises one or more electronic device with wireless communication means, commerce server, server access device, communication network, and device configurator. The wireless communication means enable the electronic device to be connected to an electronic commerce service, fulfillment, and device configuration system (herein referred to as “device customization system”). The electronic device is configured to enable seamless communication with the device customization system. The method includes pre-programming an electronic device at a manufacturing facility, factory, warehouse, or while in route to the ordering customer or other intended recipient (e.g., family member).

According to an aspect of the present disclosure, the device customization system comprises a commerce server, one or more access device, a communication network channel, a device configurator, and one or more packaged electronic device. In one embodiment, the access device is an artificial intelligence (AI) digital assistant-enabled device (e.g. Amazon Echo®/Dot®, etc.). The commerce server can communicate with one or more alternative server, including but not limited to a remote server, database server, cloud server, or a server providing cloud computing services. One or more customers can order or purchase an electronic device using an access device for shipment from a commerce server through one or more communication network channel. The communication network channels include, but are not limited to, a local area network (LAN), a wide area network (WAN), an Internet of Things (IoTs) network, a cellular network, the Internet, or, a GPS system, a mobile cellular network. The commerce server contains software applications with various functions and features, including but not limited to enabling a customer to register as a user of an account, searching for products (e.g., electronic device), and ordering or purchasing one or more products for delivery. The commerce server preferably contains application software that provides the purchaser with the option to customize one or more functional features or contents of a packaged electronic device.

According to another aspect of the present disclosure, the commerce server preferably contains a software application to control a device configurator to transmit data to one or more packaged electronic device upon the completion of the purchasing process. The device configurator can operate within the communication network. The transmitted data preferably contains instructions for configuring an electronic device's functions or additional contents beyond factory settings. In one embodiment, one or more electronic device is customized by the configuration device locally (e.g., at factory or warehouse). In another embodiment, one or more electronic device is customized via the device configurator during transit to a customer location. In an alternative embodiment, the electronic device is configured upon access to a communication network located at the customer location.

According to another aspect of the present disclosure, the electronic device includes, but is not limited to, consumer electronic devices (as described herein), home smart appliances, automobile accessories, industrial equipment, and the like. The said device preferably incorporates one or more microprocessor, microcontroller, micro GSM/GPRS chipset, micro SIM module, read-write memory device, read-only memory device (ROM), random access memory (RAM), flash memory, memory storage device, magnetic storage device, CD-ROM, memory I-O, I-O devices, buttons, display, LED, user interface, rechargeable battery, microphone, speaker, wireless transceiver (e.g., RF, WiFi, Bluetooth, IoT, RFID), RFID tag, RF electronic circuits, audio CODEC, cellular antenna, GPS antenna, WiFi antenna, Bluetooth antenna, IoT antenna, vibrating motor (output), preferably configured in combination, to function as an electronic device. The device can perform one or more executable codes, algorithms, methods, and/or software instructions stored within one or more said memory device to perform its functions. One or more said components (e.g., buttons, display, user interface, speakers, microphone) are configured to be accessible to a user.

Certain specific embodiments of the present disclosure provide for a device configuration system comprising a commerce server being operably engaged with a communications network, the commerce server comprising a processor and a non-transitory memory device configured to execute an application software, the application software being configured to receive and process purchase order data and device configuration data associated with an electronic device; an access device being configured to access an instance of the application software via the communication network, the instance of the application software being configured to provide to a user one or more purchase order fields and one or more device configuration fields; a configuration device comprising a transceiver, the configuration device being operably engaged with the commerce server via the communications network to receive one or more configuration instructions associated with the electronic device, the configuration device being configured to establish a communications link with the electronic device and communicate the one or more configuration instructions to the electronic device.

Further specific embodiments of the present disclosure provide for a method of configuring an electronic device comprising receiving, with a commerce server via a communications network, a purchase order for an electronic device; configuring, with the commerce server, a plurality of device configuration instructions being associated with the purchase order; identifying, with the commerce server, an electronic device from an inventory; transmitting, with a configuration means, the plurality of device configuration instructions to the electronic device; and configuring, on the electronic device, one or more settings according to the plurality of device configuration instructions.

Still further specific embodiments of the present disclosure provide for a device customization system comprising a commerce server being operably engaged with a communications network, the commerce server comprising a network interface, a processor and a non-transitory memory device having instructions stored thereon to cause the processor to perform one or more actions, the one or more actions comprising receiving a purchase order associated with an electronic device; receiving customization data associated with the purchase order; fulfilling the purchase order associated with the electronic device; and, configuring customization instructions associated with the electronic device; and, a configuration means being operably engaged with the commerce server via the communications network to receive the customization instructions associated with the electronic device, the configuration device being configured to establish a communications link with the electronic device and communicate the one or more customization instructions to the electronic device.

The disclosed apparatus, system, and methods overcome the limitations for programming or configuring packaged electronic devices while in storage or during transit to a customer location. Implementations of the present disclosure enable the remote personalization of purchased electronic devices before shipment, delivery, and receipt by an end user.

### BRIEF DESCRIPTIONS OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a schematic diagram illustrating a method for the purchase of an electronic device.

FIG. 2 is a flowchart of an embodiment of a method of configuring an electronic device during the fulfillment of an electronic commerce order.

FIG. 3 is a schematic diagram illustrating a system for configuring a packaged electronic device for shipment and delivery to a customer.

FIG. 4 is a schematic diagram illustrating a system for configuring a packaged electronic device while in route to a customer.

FIG. 5 is a functional block diagram of the modular components of a representative electronic device.

FIG. 6 is an illustrative example of the use of an access device and cloud computing services according to an aspect of the present disclosure.

### DETAILED DESCRIPTION

The present disclosure can be understood more readily by reference to the following detailed description, examples, drawings, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.” Like numbers refer to like elements throughout.

The terminology used herein is for describing particular embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,”, and variants thereof, when used herein, specify the presence of stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to another element, it can be directly coupled, connected, or responsive to the other element, or intervening elements can also be present. In contrast, when an element is referred to as being “directly coupled,” “directly connected,” or “directly responsive” to another element, there are no intervening elements present. As used herein, the term “and/or” includes any and all combinations of one or more of the associated listed items.

Spatially relative terms, such as “above,” “below,” “upper,” “lower,” “top, “bottom,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly. Well-known functions or constructions may not be described in detail for brevity and/or clarity.

It will be understood that, although the terms “first,” “second,” etc. can be used herein to describe various elements, these elements should not be limited by these terms. These terms are only used to distinguish one element from another. Thus, a first element could be termed a second element without departing from the teachings of the present embodiments.

Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly-formal sense unless expressly so defined herein.

In the context of the fulfillment software applications described herein, the terms “customer” and “buyer” can refer to a person, an enterprise, a business, or another organization.

Disclosed are various embodiments concerning an apparatus, system, and methods for the remote customization of functions (e.g. setup) and or contents (e.g., upgrade, music, greeting message, etc.) of a packaged electronic device within a manufacturing facility, factory, a warehouse or while in route during shipment and delivery to a customer or another recipient are described.

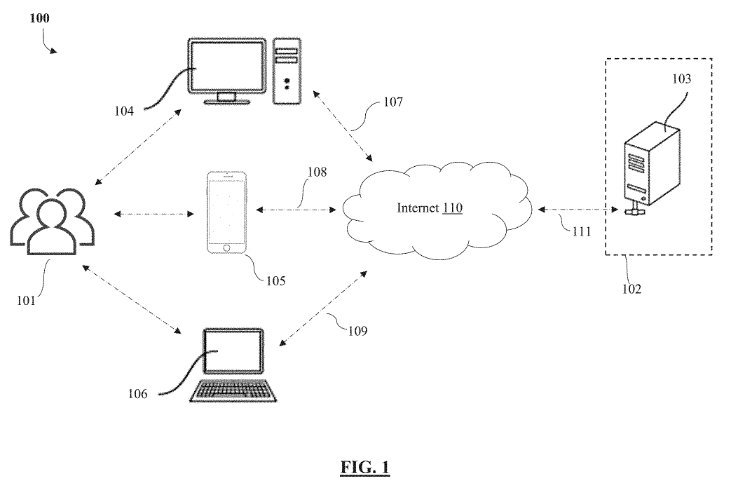

Referring to FIG. 1, schematic diagram 100 illustrates the method whereby a customer 101 can make a purchase of an electronic device from a manufacturer site 102 through an online commerce server 103. Customer 101 can access the online commerce server 103 using one or more access devices 104, 105, 106. The various access devices communicate, using respective network channels 107, 108, 109, depending on the type of device, to commerce server 103, via the Internet 110, to facilitate the purchasing process, with commerce server 103 connected to Internet 110 through network channel 111. A customer 101 in a remote location can use one or more of the access devices 104, 105, 106 to place an order for an electronic device by submitting a request to the online commerce server 103 to purchase the electronic device from the manufacturer site 102. Manufacturer site 102 can also be a fulfillment center (e.g., a factory, warehouse, ecommerce site, etc.). The customer 101, for example, can submit the request via a webpage. As part of the submission of the request, the customer 101 can also submit customization information. The customization information can include, for example, information regarding the customer's home network configuration, Bluetooth®-enabled devices within the home, other smart appliances, or the like. The customization information can include other information as described herein.

Network channels can represent any form or medium of analog or digital data communication. Examples of network channels include a local area network (“LAN”), a wireless LAN, e.g., a WiFi network, a wireless Metropolitan Area Network (MAN) that connects multiple wireless LANs, and a wide area network (“WAN”), e.g., the Internet, a private network, and an intranet. For example, the Internet can include any publicly-accessible network or networks interconnected via one or more communication protocols, including, but not limited to, hypertext transfer protocol (HTTP) and transmission control protocol/internet protocol (TCP/IP). Moreover, network channels can also include one or more wireless mobile device networks, such as a GSM network or a PCS network, that allow mobile devices to send and receive data across networks via applicable communications protocols and frequency bands. The wireless mobile device networks can include a cellular network that uses at least one of long-term evolution (LTE), LTE advanced (LTE-A), code division multiple access (CDMA), wideband CDMA (WCDMA), universal mobile telecommunication system (UMTS), wireless broadband (WiBro), and global system for mobile communication (GSM). The wireless mobile device network can include at least one of wireless fidelity (WIFI), Bluetooth®, Bluetooth® low energy (BLE), ZigBee™, near field communication (NFC), magnetic secure transmission, radio frequency (RF), Internet of Things (IoT), or body area network (BAN). The wireless mobile device network can include a global positioning system (GPS), global navigation satellite system (GNSS), Beidou navigation satellite system (Beidou), Galileo, and the European global satellite-based navigation system. Herein, “GPS” can be used interchangeably with the term “GNSS.” Additional frequency bands and equivalent band-related terminologies include Third Generation (3G), Fourth Generation (4G), Fifth Generation (5G), future generations, and the like.

Commerce server 103 can comprise a general-purpose computer (e.g., a personal computer, network computer, server, or mainframe computer) having one or more processors that can be selectively activated or reconfigured by a computer program. Further, commerce server 103 can be incorporated as a node in a distributed network. For example, commerce server can communicate via network channels with one or more additional servers (not shown), which can enable commerce server 103 to distribute processes for parallel execution by a plurality of other servers.

Commerce server 103 can include a processor, a memory, and a network interface for communicating via network channel 111. The network interface can include any communication device for sending and receiving data over network channel 111. Memory can include one or more memory devices that store data, including, but not limited to, random access memory (RAM), read-only memory (ROM), a magnetic storage device (e.g., a hard disk), an optical storage medium (e.g., a CD- or DVD-ROM), a high-definition optical storage medium, an electronic storage device (e.g., EPROM or a flash drive), and/or other data storage devices known in the art.

In one embodiment, one or more commerce servers 103 can be configured to function as a cloud server to provide cloud services. The cloud server and service are commonly referred to as “cloud computing”, “on-demand computing”, “software as a service (SaaS)”, “platform computing”, “network-accessible platform”, “cloud services”, “data centers,” and the like. As explained with regard to cloud computing generally in U.S. Patent Application Publication No. 2014/0379910 to Saxena et al., the cloud can include a collection of hardware and software that forms a shared pool of configurable computing resources (e.g., networks, servers, storage, applications, services, etc.), which can be suitably provisioned to provide on-demand self-service, network access, resource pooling, elasticity and measured service, among other features. The cloud server can be deployed as a private cloud (e.g., infrastructure operated by a single enterprise/organization), community cloud (e.g., infrastructure shared by several organizations to support a specific community that has shared concerns), public cloud (e.g., infrastructure made available to the general public, such as the Internet), or a suitable combination of two or more disparate types of clouds. In this description, “cloud computing” is defined as a model for enabling on-demand network access to a shared pool of configurable computing resources (e.g., networks, servers, storage, applications, and services). As stated in U.S. Patent Application Publication No. 2014/0075431 to Kumar et al: “Generally, a cloud computing model enables some of those responsibilities which previously may have been provided by an organization's own information technology department, to instead be delivered as service layers within a cloud environment, for use by consumers (either within or external to the organization, according to the cloud's public/private nature).” As further explained in the aforementioned Kumar et al. patent application, a cloud computing model can take the form of various service models such as, for example, Software as a Service (“SaaS”), “in which consumers use software applications that are running upon a cloud infrastructure, while a SaaS provider manages or controls the underlying cloud infrastructure and applications,” and Platform as a Service (“PaaS”), “in which consumers can use software programming languages and development tools supported by a PaaS provider to develop, deploy, and otherwise control their own applications, while the PaaS provider manages or controls other aspects of the cloud environment (i.e., everything below the run-time execution environment).” The definition of “cloud computing” is not limited to any of the other numerous advantages that can be obtained from such models when properly deployed.

The commerce server 103 can also include applications to establish a device store (not shown). The applications can include application programs that can be executed on commerce server 103, and that can be accessed by users of access devices 104, 105, and 106. For example, the applications can provide online sales and customer purchasing fulfillment processes, for example, user account registration, verification, product search, purchase, billing, and shipping. Other applications can include download or streaming applications to provide access to an electronic device library, content library, and any additional or alternate application program with which users can interact to purchase electronic device via network channel 107, 108, 109. In a preferred embodiment, the said application includes options for a customer to configure or pre-program a purchased device. The application option enables a customer to configure or personalize the purchase device with various functions or contents, including but not limited to, communication network requirements, login, passwords, security settings, communication with other devices, greetings, personal messages, personal instructions, personal contact info, upgrades, multimedia content, others described herein, or the like.

Access devices 104, 105, and 106 can each comprise a general-purpose computer, a desktop computer, a mobile phone, as described above. However, in additional embodiments, access devices 104, 105, and 106 can constitute a personal digital assistant (PDA), a portable navigation device, a smart phone, an electronic book viewer, a set top box, a television, and any additional or alternate computing device apparent to a person of ordinary skill in the art and operable to transmit and receive data across one or more said network channels, and able to display data received from commerce server 103. Access devices 104, 105, and 106 can also include alternative additional devices configured to transmit and receive data across appropriate network channels including, but not limited to, set-top boxes including a TV, smart TV, a digital video recorder (DVR), gaming console, artificial intelligent (AI) digital assistant-enabled devices (e.g., Amazon Alexa: Echo®, Dot®, Show®, FireTV®; Google Home®, Apple Home Pod™, etc.). Access devices 104, 105, and 106 can include browser applications or mobile apps capable of rendering standard Internet content, such as Netscape Navigator®, Google Chrome®, Microsoft Internet Explorer®, and/or Mozilla Firefox®. Access devices 104, 105, and 106 can use a browser application or otherwise be configured to order an electronic device over network channels 107, 108, 109, 110, 111.

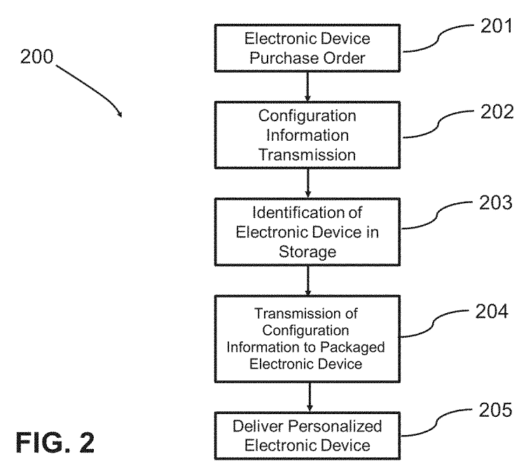

FIG. 2 illustrates a flowchart of an embodiment of a method 200 of configuring an electronic device during the electronic commerce order fulfillment. The method 200 commences, in block 201, with the receipt of an order to purchase an electronic device. The request can be received at said facility 102 of FIG. 1. The request can be received from a customer 101 of FIG. 1 via a webpage using one or more said access device. The order can include additional content or upgrade beyond the factory setting of the electronic device. The configuration order information is received in block 202 and the information is transmitted to a configuration device (details described below). As an example, but not limiting, the configuration information can include location, communication network requirements, login, passwords, security settings, communication with other devices, greetings, personal messages, personal instructions, personal contact info, upgrades, multimedia content, startup message delivered by the electronic device user interface (e.g., display, speaker), personal startup message, or the like. For example, the customer can configure the purchased device to display a message such as “Hello Mom. I ordered this smart mobile phone so we can keep in touch.” In a preferred embodiment, the messages are delivered upon the user turning on the electronic device. In block 203, the purchased electronic device is identified from storage within a manufacturing site, a factory, a warehouse, an ecommerce service provider, or the like. In block 204, the configuration information is transmitted to the identified electronic device. In block 205, the personalized electronic device is shipped. In one embodiment, the electronic device is shipped to the customer. In an alternative embodiment, the electronic device is shipped to an end user.

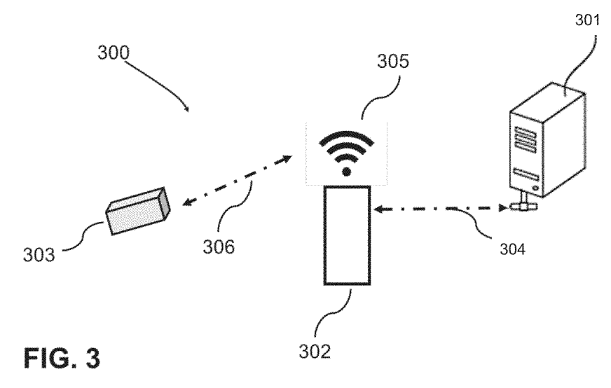

Referring to FIG. 3, schematic diagram 300 illustrates a system for configuring a packaged electronic device for shipment and delivery to a customer. Upon receipt of the device configuration transmission 202 of FIG. 2, commerce server 301, corresponding to commerce server 103 of FIG. 1, communicates with a configuration device 302 via communication network channel 304 to identify an ordered electronic device 303 from remote storage via communication network channels 305, 306. It is understood that electronic device 303 contains wireless communication means to transmit and receive data from commerce server 301 (discussed below). In one embodiment, the electronic device comprises a wireless communication means being configured in an idle state, said communication means being capable of detecting transmission requests for updating settings and contents. Upon identification of the stored electronic device, configuration device 302 establishes a communications connection to transmit the configuration information requested by the customer. Electronic device 303 receives the transmission of updated information and proceeds to store the updated information in one or more of its memory storage devices. Electronic device 303 is then ready for shipment. In one embodiment, configuration device 302 comprises one or more transceivers. The transceivers can include one or more components, but not limited to, radio frequency (RF), WiFi, Bluetooth, IoT, Infrared (IR), LED, RFID, RFID tag, RF electronic circuits, audio CODEC, cellular antenna, GPS antenna, WiFi antenna, Bluetooth antenna, IoT antenna. The wireless transceivers can be configured to communicate according to an IEEE 802.11 standard, cellular (e.g., 2G, 3G/4G/LITE/5G) standard, a GPS standard, or other standards. In addition, such a wireless communication can be implemented in accordance with one or more radio technology protocols, NFC, 3GPP LTE, LTE-A, 3G, 4G, 5G, WiMax, Wi-Fi, Bluetooth®, ZigBee®, IoT, or the like, for example.

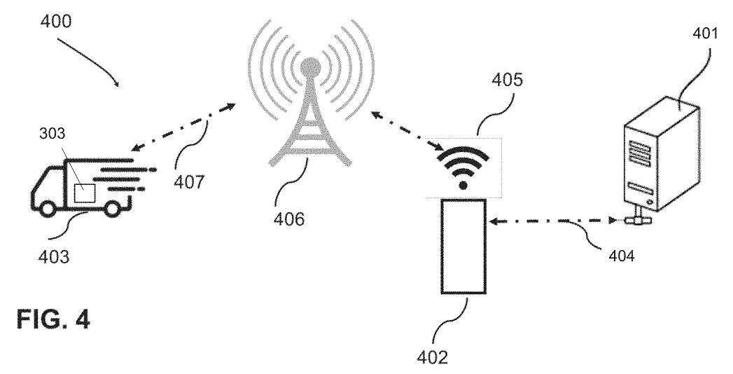

Referring to FIG. 4, schematic diagram 400 illustrates a system for configuring a packaged electronic device 303 of FIG. 3 while in route to a customer. Upon receipt of the device configuration transmission 202 of FIG. 2, commerce server 401, corresponding to commerce server 103 of FIG. 1, communicates with a configuration device 402 via communication network channel 404 to identify an ordered electronic device in transit to a customer's destination. It is understood that electronic device 303 of FIG. 3 preferably contains one or more LAN, WAN, WIFI, Bluetooth, or wireless cellular communication means (discussed below). In one embodiment, the electronic device is packaged with wireless communication means, configured to be in a powered idled state, capable of transitioning to a powered-on state, and capable of detecting data transmission requests for updating device settings and/or contents. Upon identification of the electronic device in transit, configuration device 402 establishes contact to transmit an updated configuration information. Configuration device 402 communicates with the electronic device while in transit within transport unit 403 via various communication network channels. As illustrated, but not limiting, configuration device 402 communicates with the electronic device via a wireless channel 405 of a cellular network 406, said network accessible to network channel 407. The electronic device in transit can communicate with cellular network 406 either using its internal cellular transceiver or through establishing connection to the cellular network 406 via WiFi, facilitated by, preferably, but not limited to, the transportation vehicle's own cellular transceiver, operating within cellular network 406. In one embodiment, the updated configuration information can be requested by the customer. In an alternative embodiment, the updated configuration information can be from the electronic device manufacturer, the commerce service provider or seller of the electronic device, cloud service providers associated with the electronic device, or the like. Electronic device 303 of FIG. 3 receives the transmission of updated information and proceeds to store the updated information in one or more of its memory storage devices. Electronic device 303 of FIG. 3 is configured with updated content upon receipt of delivery by the customer.

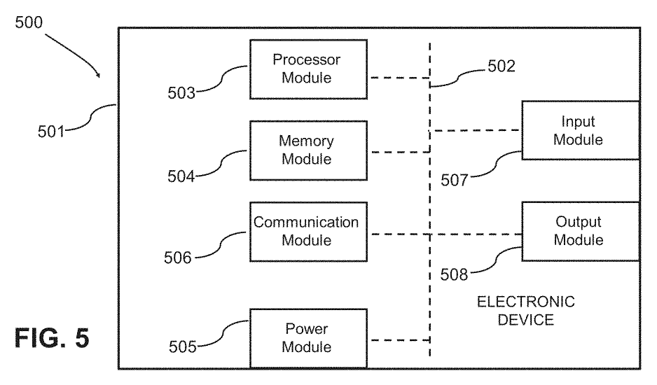

FIG. 5 illustrates a functional block diagram 500 of an embodiment representative of an electronic device 303 of FIG. 3. It is understood that the representative device includes but is not limited to consumer electronic devices, home smart appliances, automobile accessories, industrial equipment, and the like. The electronic device 501 can be any type of computing device such as a mobile phone, a smart mobile phone, a portable media player, electronic book reader, a PDA, a laptop computer, a tablet computer, a desktop computer, a CCD camera, a video CCD camera, a netbook, a gaming console, a digital video disc (DVD) player, a computing pad, a smart speaker, an AI digital assistant enabled device (e.g., Amazon Echo®, Dot®, Show®, FireTV®, Google Home®, Apple Home Pod™, or the like), smart appliances (e.g., refrigerator, thermometer, etc.), smart speaker, a wearable (e.g., Fitbit, etc.), personal diagnostic monitors (e.g., glucose meter, EEG monitor, etc.), or the like. The electronic device 501 is presumably enclosed or packaged within, for example, a box made of cardboard, Styrofoam, plastic or other similar materials, enabling the electronic device to send and receive electromagnetic signals or communication signals.

The electronic device 501 includes various components (herein the term “module” is used to represent one or more components configured to collectively perform a specific function) coupled via one or more communication buses 502. In one aspect, the bus 502 represents one or more of several possible types of bus structures, including a memory bus or a memory controller, a peripheral bus, an accelerated graphics port, and a processor or local bus using any of a variety of bus architectures. As an illustration, such architectures can include an Industry Standard Architecture (ISA) bus, a Micro Channel Architecture (MCA) bus, an Enhanced Express bus, a Personal Computer Memory Card International Association (PCMCIA) bus, a Universal Serial Bus (USB), and the like. The electronic device 501 includes one or more processor module 503, comprising one or more, but not limited to, central processing unit (CPU), microprocessor, microcontroller, or the like. The electronic device 501 also includes memory module 504, in data communication with the processor module 503, which can correspond to any combination of volatile and/or non-volatile storage devices. The memory module 504 can include one or more of read-only memory (ROM), flash memory, random access memory (RAM), dynamic random access (DRAM), synchronous DRAM (SDRAM), and static random-access memory (SRAM). The memory module 504 stores information that can include, but is not limited to, operating system instruction or software, or a variety of application software, for example software drivers to control other modules within the device. The electronic device 501 performs functions by using the processor module 503 to execute instructions provided by the memory module 504. The memory module 504 can include one or more types of removable storage (e.g., magnetic storage device (e.g., a hard disk), an optical storage medium (e.g., a CD- or DVD-ROM), a high-definition optical storage medium), and/or one or more types of said non-removable storage (e.g. ROM, RAM, flash memory). The memory module 504 can include a computer-readable storage medium on which is stored one or more sets of instructions embodying any one or more of the methodologies or functions described herein. The memory module 504 can include functionality instructions storage and functionality information storage. The functionality instructions storage can include computer-accessible instructions that, in response to execution (by at least one of the processor(s)), can implement one or more of the functionalities specific to an electronic device described herein. The computer accessible instructions can embody or can include one or more software components that are pre-programmed, configured or upgraded described herein. In one scenario, execution of at least one component of the customization, personalization, or upgrade can implement one or more of the methods described herein. For instance, such execution can cause a processor (e.g., one of the processor(s) that executes the at least one component) to carry out a disclosed example method. It should be appreciated that, in one aspect, a processor of the processor module 503 that executes at least one of the upgrades can retrieve information from or retain information in one or more memory elements of the memory module in the functionality information storage in order to operate in accordance with the functionality programmed or otherwise configured by the upgrade. Such information can include at least one of code instructions, information structures, or the like.

The electronic device 501 includes a power module 505 for providing power to the various other components of the electronic device 501. The power module 505 can include one or more rechargeable or non-rechargeable battery. The power module 505 can include an interface for connecting to an external power supply to recharge the battery. The processor module 503 can determine a charge level of the battery.

The electronic device 501 can include a wireless communication module 506 comprising one or more transceiver for wirelessly receiving and/or transmitting information. The transceivers can include the following components, but not limited to, radio frequency (RF), WiFi, Bluetooth®, IoT, Infrared (IR), LED, RFID, RFID tag, RF electronic circuits, audio CODEC, cellular antenna, GPS antenna, WiFi antenna, Bluetooth® antenna, IoT antenna. The wireless transceivers can be configured to communicate according to an IEEE 802.11 standard, cellular (e.g., 3G/4G/5G/LITE) standard, a GPS standard, or other standards. In addition, such a wireless communication can be implemented in accordance with one or more radio technology protocols, for example, such as NFC, 3GPP LTE, LTE-A, 3G, 4G, 5G, WiMax, Wi-Fi, Bluetooth®, ZigBee®, IoT, or the like.

In a preferred embodiment, the configuration or upgrading information can include installing the information for a first time in a packaged electronic device, and/or replacing or otherwise modifying information in existence or otherwise present in the packaged electronic device. In one aspect, processor module 503 of electronic device 501 is capable of controlling power module 505 to transition or switch from an idled state to a power-on state while contained in its unopened packaging. After such a transition, the electronic device 501 can be referred to as being energized. In certain embodiments, the electronic device can be caused to transition from the power-on state to the power-idle state, whereby communication module 506 of the electronic device can receive a transmission signal to perform the requested device configuration update or software upgrade.

The electronic device 501 can incorporate an input module 507 comprising one or more input devices. The input devices can include a keyboard, a mouse device, microphone, voice-controlled speech interface, sensor, CCD detector, sensors, and the like. The electronic device 501 can incorporate an output module 508 comprising one or more output devices. The output devices can include displays, touch screens, printers, audio output devices (e.g. speaker, vibrating motor), LED, LED display, E-Ink display, or other output devices. The input/out interfaces of input-out (I/O) modules 507 and 508 can permit communication of information between the computing device and an external device, such as another computing device, e.g., a network element or an end-user device. Such communication can include direct communication or indirect communication, such as exchange of information between the electronic device 501 and the external device via a network or elements thereof. The I/O interfaces can include one or more of network adapter(s), peripheral adapter(s), and rendering unit(s). Such adapter(s) can permit or facilitate connectivity between the external device and one or more of the processor module 503 or the memory module 504. For example, the peripheral adapter(s) can include a group of ports, which can include at least one of parallel ports, serial ports, Ethernet ports, V.35 ports, or X.21 ports. In certain embodiments, the parallel ports can include General Purpose Interface Bus (GPIB), IEEE-1284, while the serial ports can include Recommended Standard (RS)-232, V.11, Universal Serial Bus (USB), FireWire or IEEE-1394.

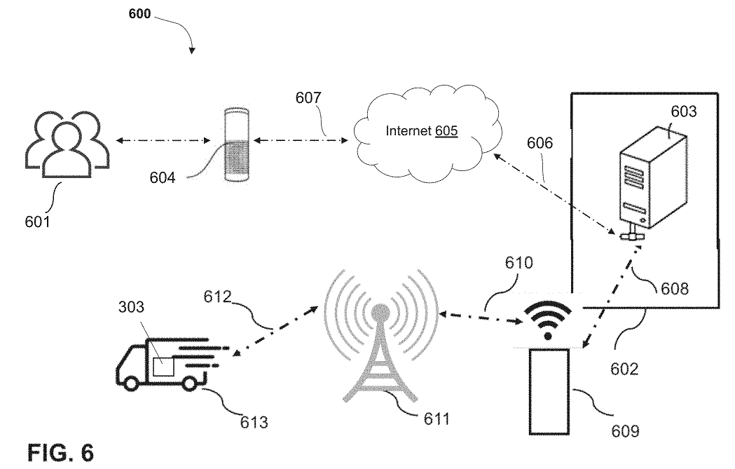

FIG. 6 is an illustrative example 600 of the use of an access device and cloud computing services according to an aspect of the present disclosure. Exemplary computing services include, but are not limited to, Amazon Web Services®, Amazon Lex™, Amazon Lambda™, Google Assistant™, Apple Siri®, Microsoft Cortana®, Samsung's Bixby®, or the like. Customer 601 wishes to purchase an electronic device described herein from an ecommerce service provider 602 (e.g., Amazon.com®) to be delivered to a home or another recipient. Commerce service provider 602 hosts its service on a cloud computing platform residing in one or more server 603. In FIG. 6, commerce server 602 has been configured to provide cloud-based computing and or control services, for example, to perform automated voice recognition and natural language understanding. Access device 604, functioning in concert with commerce service provider 602, can be capable of detecting audio inputs/listens and can interact with customer 601 to determine a user intent based on natural language understanding of the user's speech. Access device 604 can be configured to capture user utterances and provide them to the control service located on server 602. The control service performs speech recognition-response and natural language understanding-processing on the utterances to determine intents expressed by the utterances. In response to an identified intent, the controlled service causes a corresponding action to be performed. In this illustrative example, customer 601 wishes to purchase an electronic device for delivery, through a voice-controlled interface of access device 604. Customer 601 initiates the process by using voice commands, such as, for example, “Alexa, is the latest iPhone available for purchase?” Access device 604 relays the command to control server 602 via communication channel 607, the Internet 605, and communication channel 606. Commerce server 602 processes the customer requested command and subsequently transmits data back to access device 604 to provide response to the customer command. Access device 604 can respond with, for example, “Yes, iPhone version 10 is available for purchase. Would you like to order it for delivery?” In this illustrative embodiment of FIG. 6, customer 601 may decide to purchase the electronic device and instruct the AI digital assistant-enabled access device 604 to proceed with the purchase of the device by providing the necessary information to complete the task. Subsequently, commerce service provider 602 processes the shipment of the purchased and packaged electronic device. In an embodiment, while in transit, customer 601 may decide that instead of sending the purchase to home, customer 601 would like to ship it to another recipient (e.g., Mom), and to include changes in device configuration suitable for use at the recipient's location or a suitable greeting message (e.g., for example, “Hello Mom. I bought this phone for you for Mother's Day.”). In this event, customer 601, using access device 604, requests commerce service provider 602 to make the required changes to the order. Upon receiving instructions, commerce server 603, corresponding to commerce server 103 of FIG. 1, communicates with a configuration device 609, corresponding to configuration device 402 of FIG. 4, via communication network channel 608 to identify the ordered electronic device in transit to customer 601's destination. Upon identification of the electronic device in transit, configuration device 609 establishes contact to transmit the requested updated information. Configuration device 609 communicates with the electronic device while in transit within transport unit 613 via various communication network channels. As illustrated, but not limiting, configuration device 609 can communicate with the electronic device via a wireless channel 610 of a cellular network 611, subsequently via communication channel 612. As such, the purchased electronic device is re-configured with updated content upon receipt of delivery.

In one implementation, the control service of commerce server 603 can provide speech services implementing an automated speech recognition (ASR) function, a natural language understanding (NLU) function, an intent router/controller, and one or more applications providing commands back to the voice-controlled access device 604, any AI digital assistant capable device, smart phone app, or the like. The ASR function can recognize human speech in an audio signal transmitted by the voice-controlled speech interface device received from a built-in microphone. The NLU function can determine a user intent based on user speech that is recognized by the ASR components. The speech services can also include speech generation functionality that synthesizes speech audio. The control service can also provide a dialog management component configured to coordinate speech dialogs or interactions with the user in conjunction with the speech services. Speech dialogs can be used to determine the user intents using speech prompts. One or more applications can serve as a command interpreter that determines functions or commands corresponding to intents expressed by user speech. In certain instances, commands can correspond to functions that are to be performed by the voice-controlled speech user interface device and the command interpreter can in those cases provide device commands or instructions to the voice-controlled speech user interface device for implementing such functions. The command interpreter can implement “built-in” capabilities that are used in conjunction with the voice-controlled speech user interface device. The control service can be configured to use a library of installable applications including one or more software applications or skill applications used in various implementations of the present disclosure. The control service can interact with other network-based services (e.g., Amazon Lambda™, Google Cloud®) to obtain information, access additional databases, applications, or services on behalf of the user. A dialog management component is configured to coordinate dialogs or interactions with the user based on speech as recognized by the ASR component and/or understood by the NLU component. The control service can also have a text-to-speech component responsive to the dialog management component to generate speech for playback on the voice-controlled speech user interface device. These components can function based on models or rules, which can include acoustic models and specify grammar, lexicons, phrases, responses, and the like created through various training techniques. The dialog management component can utilize dialog models that specify logic for conducting dialogs with users. A dialog comprises an alternating sequence of natural language statements or utterances by the user and system generated speech or textual responses. The dialog models embody logic for creating responses based on received user statements to prompt the user for more detailed information of the intents or to obtain other information from the user. An application selection component or intent router identifies, selects, and/or invokes installed device applications and/or installed server applications in response to user intents identified by the NLU component. In response to a determined user intent, the intent router can identify one of the installed applications capable of servicing the user intent. The application can be called or invoked to satisfy the user intent or to conduct further dialog with the user to further refine the user intent. Each of the installed applications can have an intent specification that defines the serviceable intent. The control service uses the intent specifications to detect user utterances, expressions, or intents that correspond to the applications. An application intent specification can include NLU models for use by the natural language understanding component. In addition, one or more installed applications can contain specified dialog models that create and coordinate speech interactions with the user. The dialog models can be used by the dialog management component in conjunction with the dialog models to create and coordinate dialogs with the user and to determine user intent either before or during operation of the installed applications. The NLU component and the dialog management component can be configured to use the intent specifications of the applications either to conduct dialogs, to identify expressed intents of users, to identify and use the intent specifications of installed applications, in conjunction with the NLU models and dialog modes, to determine when a user has expressed an intent that can be serviced by the application, and to conduct one or more dialogs with the user. As an example, in response to a user utterance, the control service can refer to the intent specifications of multiple applications, including both device applications and server applications, to identify a “device personalization” intent. The service can then invoke the corresponding application or “skill” containing instructions as to for example, automate the process of controlling the configuration device to pre-program a packaged electronic device. Upon invocation, the application can receive an indication of the determined intent and can conduct or coordinate further dialogs with the user to elicit further intent details. Upon determining sufficient details regarding the user intent, the application can perform its designed functionality in fulfillment of the intent (e.g., personalization of an electronic device). In one embodiment, said “skill” can be developed using application tools from vendors (e.g., Amazon Web Services®, Alexa® Skill Kits, Google®, Apple®, Samsung®) providing cloud control services.

Many different embodiments have been disclosed regarding the above descriptions and the drawings. It will be understood that it would be unduly repetitious to literally describe and illustrate every combination and sub-combination of these embodiments. Accordingly, the present specification, including the drawings, shall be construed to constitute a complete written description of all combinations and sub-combinations of the embodiments described herein, and of the manner and process of making and using them, and shall support claims to any such combination or sub-combination. In the drawings and specification, there have been disclosed various embodiments and, although specific terms are employed, they are used in a generic and descriptive sense only and not for purposes of limitation. Therefore, it will be apparent to those skilled in the art that various modifications and variations can be made to the disclosed embodiments without departing from the scope or spirit of the disclosure. All such modifications and variations are intended to be included herein within the scope of the present disclosure, and all possible claims to individual aspects or combinations of elements or steps are intended to be supported by the present disclosure.

What is claimed is:

1. A device configuration system comprising:
a commerce server being operably engaged with a communications network, the commerce server comprising a network interface, a processor and a non-transitory memory device configured to execute an application software, the application software being configured to receive and process purchase order data and device configuration data associated with an electronic device;
an access device being configured to access an instance of the application software via the communications network, the instance of the application software being configured to provide to a user one or more purchase order fields and one or more device configuration fields; and
a configuration device comprising a transceiver, the configuration device being operably engaged with the commerce server via the communications network to receive one or more configuration instructions associated with the electronic device, the configuration device being configured to establish a communications link with the electronic device and communicate the one or more configuration instructions to the electronic device.

2. The device configuration system of claim 1 wherein the electronic device is configured to receive the one or more configuration instructions from the configuration device via the communications link.

3. The device configuration system of claim 2 wherein the electronic device is configured to update one or more device settings according to the one or more configuration instructions.

4. The device configuration system of claim 1 wherein the instance of the application software is further configured to enable the user to select one or more electronic devices for purchase.

5. The device configuration system of claim 2 wherein the electronic device is configured to communicate a transit confirmation to the configuration device.

6. The device configuration system of claim 5 wherein the electronic device is configured to update one or more device settings according to the one or more configuration instructions in response to the transit confirmation.

7. The device configuration system of claim 2 wherein the electronic device is configured to update one or more device settings according to the one or more configuration instructions in response to accessing a communications network associated with a user location.

8. The device configuration system of claim 1 wherein the application software is further configured to associate the purchase order data and device configuration data with an electronic device identifier.

9. A method of configuring a device comprising:
receiving, with a commerce server via a communications network, a purchase order for an electronic device;
configuring, with the commerce server, a plurality of device configuration instructions being associated with the purchase order;
identifying, with the commerce server, the electronic device from an inventory;
transmitting, with a configuration means, the plurality of device configuration instructions to the electronic device; and,
configuring, on the electronic device, one or more settings according to the plurality of device configuration instructions.

10. The method of claim 9 further comprising inputting, with an access device, a plurality of device configuration data.

11. The method of claim 9 further comprising establishing a communications link with the electronic device from the inventory.

12. The method of claim 9 further comprising shipping the electronic device to an end user.

13. The method of claim 9 further comprising communicating, with the electronic device, a transit confirmation.

14. The method of claim 13 further comprising transmitting, with the configuration means, the plurality of device configuration instructions to the electronic device in response to the transit confirmation.

15. A device customization system comprising:
a commerce server being operably engaged with a communications network, the commerce server comprising a network interface, a processor and a non-transitory memory device having instructions stored thereon to cause the processor to perform one or more actions, the one or more actions comprising:
receiving a purchase order associated with an electronic device;
receiving customization data associated with the purchase order;
fulfilling the purchase order associated with the electronic device; and,
configuring customization instructions associated with the electronic device; and,
a configuration means being operably engaged with the commerce server via the communications network to receive the customization instructions associated with the electronic device, the configuration means being configured to establish a communications link with the electronic device and communicate the customization instructions to the electronic device.

16. The device customization system of claim 15 wherein the one or more actions further comprise identifying the electronic device from an inventory.

17. The device customization system of claim 15 wherein the electronic device is communicably engaged with the configuration means via a wireless communication means.

18. The device customization system of claim 17 wherein the electronic device is configured to send a transit confirmation to the configuration means.

19. The device customization system of claim 18 wherein the configuration means is configured to communicate the customization instructions to the electronic device in response to the transit confirmation.

20. The device customization system of claim 15 wherein the electronic device is configured to update one or more settings in response to the customization instructions.
